(19) United States
(12) Patent Application Publication
(10) Pub. No.: US 2025/0128393 A1
(43) Pub. Date: Apr. 24, 2025

(54) JAW BIASING ASSEMBLY FOR A POWER TOOL

(71) Applicant: Milwaukee Electric Tool Corporation, Brookfield, WI (US)

(72) Inventors: Jean Mauricio Uruena Montoya, Wauwatosa, WI (US); Benjamin James Tretow, Mequon, WI (US); Rishiraj Gaddam, Brookfield, WI (US)

(21) Appl. No.: 18/920,205

(22) Filed: Oct. 18, 2024

Related U.S. Application Data
(60) Provisional application No. 63/591,739, filed on Oct. 19, 2023.

(51) Int. Cl. B25F 5/00; B25F 3/00; B26D 3/00

(52) U.S. Cl. CPC B25F 5/005; B25F 3/00; B26D 3/003

(57) ABSTRACT

A power tool includes an actuator having a ram that is movable between a first position and a second position. A first jaw and a second jaw are moveable relative to one another between a first configuration when the ram is in the first position and a second configuration when the ram is in the second position. A first spring is coupled to each of the first jaw and the second jaw to apply a first force to bias the first jaw and the second jaw to the first configuration. A return assembly applies a second force to bias the first jaw to the first configuration.

### RELATED APPLICATIONS

This application claims the benefit of U.S. Provisional Patent Application No. 63/591,739, filed Oct. 19, 2023, which is incorporated herein by reference in its entirety.

### FIELD

The present disclosure relates generally to power tools. More particularly, the present disclosure relates to a return assembly that is utilized to bias jaws of a power tool from a closed position to an open position.

### BACKGROUND

Powered cutting tool often include a cutting head with opposed jaws that include certain crimping and cutting features, depending on the particular configuration of the tool. Some powered cutting tools are hydraulic power tools that include a piston configured to exert a force on the cutting head to actuate the jaws of the cutting head, and thus perform cutting, crimping, or punching work at a targeted location. Powered cutting tools can be used to cut wood, metal, plastic, and rubber. In particular, hydraulic cutting tools can be used to cut tires.

### SUMMARY

Aspects of the invention provide improved biasing assemblies for jaws of a power tool. Such biasing assembly arrangements can provide increased biasing forces that can return jaws to a desired position.

According to one aspect of the present disclosure, a power tool can include a housing and an actuator disposed within the housing. The actuator can include a ram that is movable between a first position and a second position. A first jaw and a second jaw can move relative to one another between a first configuration when the ram is in the first position and a second configuration when the ram is in the second position. A first spring can be coupled to each of the first jaw and the second jaw to apply a first force to bias the first jaw and the second jaw to the first configuration. A return assembly can apply a second force to bias the first jaw to the first configuration.

According to another aspect of the present disclosure, a power tool can include a housing and an actuator disposed within the housing. The actuator can include a ram that is movable between a retracted position and an extended position. A first jaw and a second jaw can be pivotally coupled to move between an open configuration when the ram is retracted and a closed configuration when the ram is extended. Each of the first jaw and the second jaw can include a tang that engages with the ram and a distal end that includes a blade. A first spring can be coupled to the tang of each of the first jaw and the second jaw to apply a first force to bias the first jaw and the second jaw to the open configuration. A return assembly can be coupled to the tang of the first jaw to apply a second force to bias the first jaw to the open configuration.

According to yet another aspect of the disclosure, a power tool can include a housing and yoke coupled to the housing. The yoke can include a first leg and a second leg that are spaced from one another to define a gap. An actuator can include a ram that is movable between a retracted position and an extended position. A first jaw and a second jaw can be pivotally coupled at the yoke to move between an open configuration when the ram is retracted and a closed configuration when the ram is extended. Each of the first jaw and the second jaw can include a tang that engages with the ram and a distal end that includes a blade. A first spring can be coupled to the first jaw and the second jaw to apply a first force to bias the first jaw and the second jaw to the first configuration. The first spring can be positioned within the gap. A second spring can provide a second biasing force to the first jaw. The second spring can be positioned external to the gap.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings.

FIG. 1 illustrates a hydraulic tool according to the present disclosure.

FIG. 2 illustrates a schematic diagram of the hydraulic tool of FIG. 1.

FIG. 3 illustrates an example working head of the hydraulic tool of FIG. 1, including a first example return assembly.

FIG. 4 illustrates a partial cross-section of the working head of FIG. 3.

FIG. 5 illustrates another example working head of the hydraulic tool of FIG. 1, including a second example return assembly.

FIG. 6 illustrates a partial cross-section of the working head of FIG. 5.

FIG. 7 illustrates another example working head of the hydraulic tool of FIG. 1, including a third example return assembly.

FIG. 8 illustrates a partial cross-section of the working head of FIG. 7.

FIG. 9 illustrates another example working head of the hydraulic tool of FIG. 1, including a fourth example return assembly.

### DETAILED DESCRIPTION

As briefly described above, hydraulic tools can be used to cut materials such as wood, metal, and rubber. Generally, hydraulic cutting tools include a cylinder and piston configuration, in which the piston is configured to extend and retract within the cylinder, and thus, move jaws, or any other implement coupled to the piston to perform work (e.g., a cut, a punch, a crimp, etc.) on a workpiece.

Conventional hydraulic tools generally utilize hydraulic pressure to extend a piston within a cylinder from a home position (e.g., a first position) to a work position (e.g., a second position). As the piston is extended from the home position to the work position, the piston acts to advance a set of jaws from a first position (e.g., one of an open position or a closed position) to a second position (e.g., the other of the closed position and the open position) to perform work on a workpiece. Furthermore, once the jaws have performed the desired work (e.g., cutting, crimping, or punching), the hydraulic pressure acting on the piston is relieved, and the piston is returned to a home position via a spring or other biasing element disposed within the cylinder. However, in some examples, as the piston retracts and ceases to act upon the jaws, conventional hydraulic tools fail to efficiently bias the jaws from the closed position to the open position (e.g., due to binding of the jaws on a workpiece). As a specific example, jaws of conventional hydraulic tools that are utilized to cut tires, and other multi-component materials, can become jammed during the cutting process due to materials such as rubber, steel wire, or other metal cording becoming lodged between cutting blades of the jaws. Jamming of the cutting blades can slow the cutting process by reducing an ability of the cutting blades to move from the closed position to the open position. As such, there is a general need for hydraulic tools that include a reliable return mechanism configured to bias jaws of the tool from the closed position to the open position against an exterior force, such as a jamming force, to increase the efficiency of cutting complex materials such as tires.

Generally, embodiments of the invention provide a hydraulic tool, including a pump, a piston disposed within a cylinder, and a work head. The pump may supply fluid to the hydraulic cylinder to extend the piston within the cylinder and thus actuate the work head. The work head can include a first jaw and a second jaw that are actuatable between an open position (e.g., a first configuration), to receive a workpiece, and a closed position (e.g., a second configuration), to cut, crimp, punch or otherwise perform work on the workpiece. Extending the piston within the cylinder can cause the piston to act upon the work head to actuate the jaws to move from the open position to the closed position. Additionally, retracting the piston within the cylinder removes an actuation force on the work head that biases the jaws to the closed position, and allowing the jaws of the work head to move from the closed position to the open position. A first spring is coupled between the first jaw and the second jaw to provide a first force to bias the jaws to the open position. In some cases, the first spring is coupled to tangs of the jaws. The first spring can be positioned between arms of a yoke, and more specifically, internal to the tangs (e.g., in recesses formed in the tangs). The ends of the spring can be secured with fasteners (e.g., bolts, pins, etc.). In some cases, a cover can be coupled over the first spring. It is appreciated that, in other examples, other arrangements are possible and that the first spring can be used to bias the jaws open or closed, and correspondingly, the ram can be arranged so that extension of the ram causes opening or closing of the jaws.

Some embodiments of the invention provide a return mechanism to provide additional force (e.g., a second force) to return jaws to a desired position. More specifically, some embodiments of the invention include a return mechanism that provides a biasing force to aid the return of the jaws from the closed position to the open position. The return mechanism can ensure that movement of the jaws from the closed position to the open position is not impeded by a material situated therebetween. The return mechanism thus ensures a smooth and efficient cutting process and can provide additional force to return to the jaws to a desired configuration following a work operation. Embodiments of the return mechanism described herein include a biasing member that is configured to act upon the first jaw and/or the second jaw to bias the jaws from the closed position to the open position. As described further below, the biasing members can include a biasing member (e.g., a resilient member, a linkage, etc.)

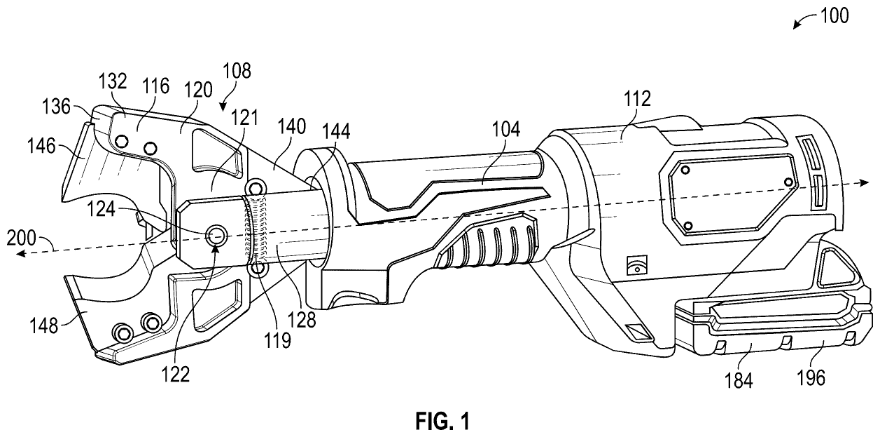

FIG. 1 illustrates certain components of a hydraulic tool 100, in accordance with an example implementation. Although the example implementation described herein references a cutting tool (e.g., a tire bead cutter), it should be understood that the features of this disclosure can be implemented in other similar tools, such as crimping tools or punching tools. The illustrated hydraulic tool 100 includes a body 104 (e.g., a cylinder, a motor, a reservoir, electronics, etc.) and a work head 108. The body 104 can be disposed within a housing 112 and the work head 108 can be coupled to the housing 112. As described further below, the work head 108 can include actuatable blades configured to engage with a workpiece. In the illustrated example, the work head 108 is a cutting head. However, alternative styled work heads may also be used for crimping, cutting, or punching, including, blades, jaws, crimping dies, etc.

The work head 108 of FIG. 1 includes a first jaw 116 and a second jaw 120 that are actuatable between an open position, in which the work head 108 is configured to receive a workpiece, and a closed position, in which the work head 108 is configured to perform work (e.g., cutting, crimping, or punching) on the workpiece. In some examples, the jaws 116, 120 are both rotatable relative to one another, such that the jaws 116, 120 rotate between an open position and a closed position. However, in other examples, one of the jaws 116, 120 may instead be fixed or not rotatable relative to the work head 108. Accordingly, the jaws 116, 120 can be moved between an open position (e.g., a first position) to allow a workpiece to be positioned in a cutting zone bounded by the jaws 116, 120 (e.g., by blades that are coupled to or formed with the jaws 116, 120), and a closed position (e.g., a second position) where the jaws 116, 120 are closed to cut the workpiece.

In some examples, the jaws 116, 120 be removably coupled to the work head 108, to allow the jaws 116, 120 to be removed or exchanged. In the illustrated example of FIG. 1, the first jaw 116 and the second jaw 120 are each coupled to the work head 108 via a clevis pin 124. Specifically, the clevis pin 124 couples the jaws 116, 120 to a work body 128 (e.g., a yoke) of the work head 108 that extends from the housing 112. Additionally, the jaws 116, 120 may be rotatable or actuatable about the clevis pin 124.

Still referring to FIG. 1, the first jaw 116 and the second jaw 120 may each include an ear 121 having an opening 122 configured to receive a clevis pin 124 so that the jaws 116, 120 can rotate relative to one another. Each of the jaws 116, 120 can further include a distal jaw section 132 (e.g., a blade holder or a blade section) that extends from the clevis pin 124 to a distal jaw end 136, opposite the housing 112 of the hydraulic tool 100. Additionally, the first jaw 116 and the second jaw 120 may each include a proximal jaw section 140 (e.g., a tang) that extends from the clevis pin 124 toward the housing 112 to a proximal jaw end 144. As illustrated in FIG. 1, the distal jaw sections 132 of the first jaw 116 and the second jaw 120 include a first blade 146 and a second blade 148, respectively. The blades 146, 148 are removably coupled to the blades 146, 148 via a fasteners (e.g., a pin, a screw, a retainer, etc.), to allow the blades 146, 148 to be removed or exchanged. In some examples, the blades 146, 148 may comprise a different material than the jaws 116, 120. For example, the blades 146, 148 may comprise a harder material (e.g., a tool steel) than the jaws 116, 120 in order to withstand the stresses of cutting when in use and provide improve cutting edge retention for longer blade life.

As described further below, when the work head 108 is actuated, the first jaw 116 and the second jaw 120 may rotate in opposite directions around the clevis pin 124 to perform work. Specifically, during actuation, the distal jaw sections 132 of the first and second jaws 116, 120, including the first and second blades 146, 148, may rotate toward one another to engage a work piece disposed between the first and second blades 146, 148, while the proximal jaw sections 140 of the first and second jaws 116, 120 rotate away from one another. However, in other examples, one of the first jaw 116 and the second jaw 120 is instead fixed in place, while the other jaw is movable or rotatable. As described further below, in some examples, a return assembly may advantageously act upon the distal jaw sections 132 or the proximal jaw section 140 to aid the movement of the jaws 116, 120 between the closed position and the open position.

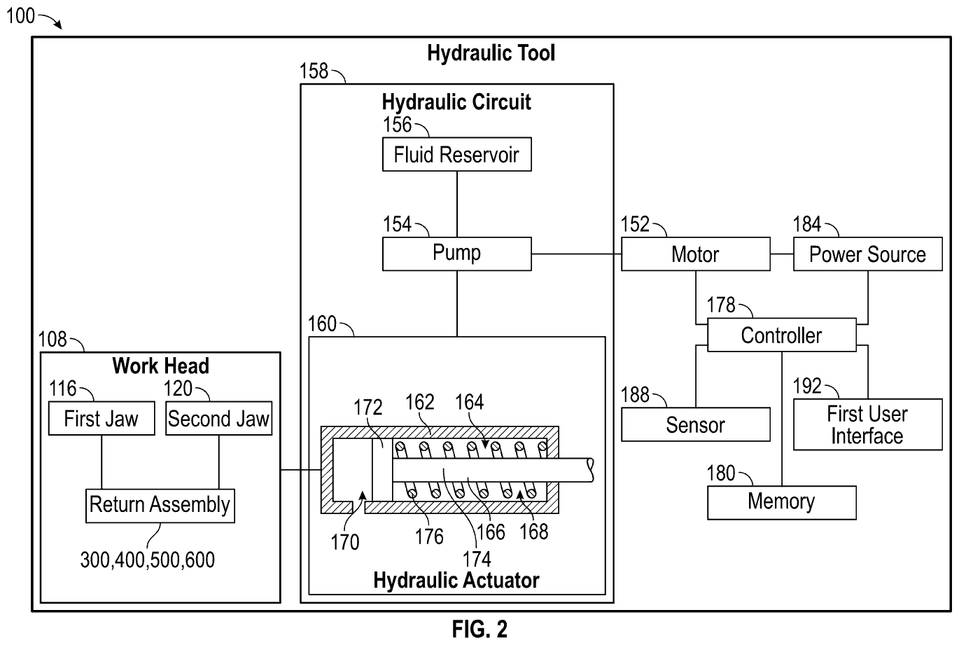

As described above, the hydraulic tool 100 can include a hydraulic actuation system that is configured to move the jaws 116, 120 between the open position to the closed position. FIG. 2 illustrates a block diagram of certain components of the hydraulic tool 100 illustrated in FIGS. 1 and 3-9. As illustrated in FIG. 2, the hydraulic tool 100 includes an electric motor 152 configured to drive a pump 154. The pump 154 is connected to a fluid reservoir 156 by a hydraulic circuit 158. The hydraulic circuit 158 further connects the pump 154 to a hydraulic actuator 160. The hydraulic actuator 160 includes a cylinder 162 defining an interior volume 164. A piston 166 is movably received within the cylinder 162 and divides the interior volume 164 into a first chamber 168 and a second chamber 170 that are on opposed sides of a head 172 of the piston 166. A ram 174 (e.g., a piston rod) is coupled to the head 172 of the piston 166 and extends out of the cylinder 162 to engage the jaws 116, 120. The piston 166 is configured to move (e.g., extend) within the cylinder 162 in response to pressurized hydraulic fluid being delivered to the cylinder 162 (e.g., to the first chamber 168) by the pump 154. A return spring 176 can be positioned in at least one of the first chamber 168 and the second chamber 170. The return spring 176 stores energy (e.g., via compression or extension) when the hydraulic fluid is supplied to the first chamber 168 to move the jaws 116, 120 from the open position to the closed position. The return spring 176 releases the stored energy (e.g., via decompression or retraction) when fluid is no longer supplied to the first chamber 168 and the first chamber 168 is fluidly coupled to the fluid reservoir 156. This causes the piston 166 to retract to move the jaws 116, 120 from the closed position to the open position.

To move the jaws 116, 120 a first spring 119 can be provided. The first spring 119 is coupled between the first jaw 116 and the second jaw 120 to provide a first force to bias the jaws 116, 120 to the open position. In some cases, the first spring 119 is coupled to the proximal jaw sections 140 of the jaws 116, 120. The first spring 119 can be positioned within a gap between legs of the work body 128, and more specifically, internal to the proximal jaw sections 140 (e.g., in recesses form in the proximal jaw sections 140). The ends of the spring 119 can be secured with fasteners (e.g., bolts, pins, etc.). In some cases, a cover can be coupled over the first spring 119 (e.g., with a first cover coupled to the first jaw 116 and a second cover coupled to the second jaw 120).

In some examples, certain functions of hydraulic tools can be controlled by a computing device. For example, the hydraulic tool can include a controller 178. The controller 178 may include a processor, a memory 180, and a communication interface. The memory 180 may include instructions that, when executed by the processor, cause the controller 178 to operate the tool 100. In one arrangement, the controller communication interface enables the controller 178 to communicate with various components of the tool 100 such as user interface components, the motor 152, memory 180, a power source 184, a sensor 188, a user interface 192, and various components of the hydraulic circuit 158. The power source 184 may be a battery that may be removably connected to a portion of the hydraulic tool, such as a battery receptacle 196 of the housing 112 of the hydraulic tool 100, as illustrated in FIG. 1.

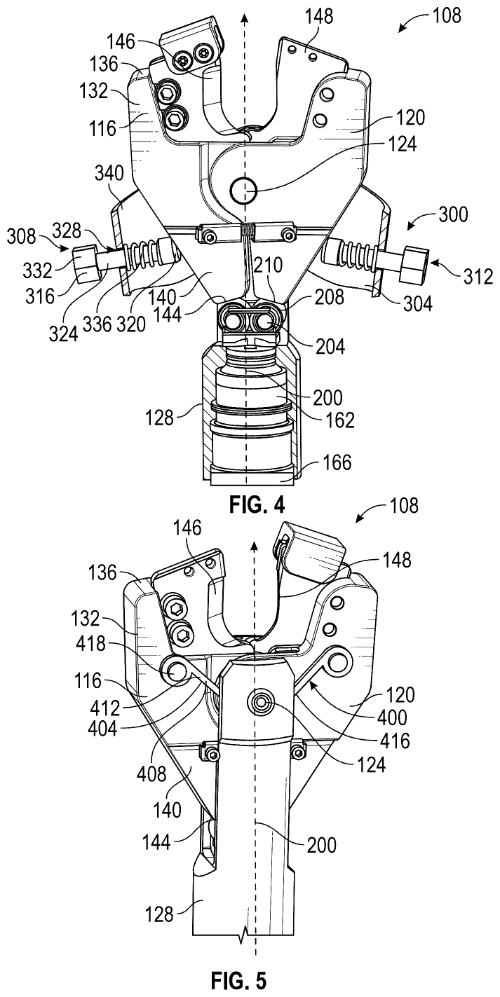

In some examples, the piston 166 is extendable along an extension axis 200 within the cylinder 162 to actuate the work head 108. Specifically, when pressurized fluid is provided to the cylinder 162 by way of the pump 154 (as shown in FIG. 2), the fluid acts on the piston 166 inside the cylinder 162, and causes the piston 166 to extend toward the work head 108. As illustrated in FIG. 4, the piston 166 can be coupled to a ram head 204 that is configured to act upon the work head 108. In some examples, the ram head 204 may convert the linear extension of the piston 166 to rotational movement of the jaws 116, 120 about the clevis pin 124. Specifically, linear actuation of the piston 166 and thus the ram head 204 may drive the proximal jaw sections 140 away from one another, consequently rotating the jaws 116, 120 about the clevis pin 124 and driving the distal jaw sections 132, and thus the blades 146, 148, toward one another to act upon a workpiece.

Referring to FIG. 4, in some examples, the ram head 204 may include a roller 208 (e.g., a roller carrier coupled to the ram 204, which rotatably supports the roller 208) configured to contact the proximal jaw ends 144 to drive rotation of the jaws 116, 120. For example, the proximal jaw ends 144 may each define a cam surface 210 that is configured to contact and engage the roller 208 of the ram head 204. In some examples, when the jaws 116, 120 are in the open position, the cam surfaces 210 can be angled obliquely relative to the extension axis 200. For example, the cam surfaces 210 can be angled so that a distance between the cam surfaces 210, measured perpendicular to the extension axis 200, tapers (e.g., decreases) moving towards the ears 121. Specifically, the distance between the cam surfaces 210 can taper in a direction that is from the housing 112 and toward the clevis pin 124, so that the angled cam surfaces 210 can act as a guide for the extension of the ram head 204, and thus the piston 166. Additionally, the roller 208 contacting the proximal jaw ends 144 can be permitted to roll along the cam surfaces 210 as the ram head 204 is driven by the piston 166, consequently reducing friction between the ram head 204 and the cam surfaces 210 and encouraging rotation of the jaws 116, 120 from the open position to the closed position.

As mentioned above, to increase performance of the hydraulic tool 100, it may be desirable to provide a greater biasing force to aid the movement of the jaws 116, 120 from the closed position to the open position. Put another way, a return mechanism can move the jaws 116, 120 to a default position when the piston 166 is in a home position (e.g., a retracted position or extended position) For example, it may be advantageous for a tool to include a return mechanism that is configured to overcome a jamming force of a workpiece, such as a tire lodged between the jaws 116, 120, that is biasing the jaws 116, 120 toward the closed position. Accordingly, a return assembly can be provided, which can be optionally used with the first spring 119. When used with the first spring 119, the return assembly can provide a second biasing force. The second biasing force can be greater than the first biasing force of the first spring 119.

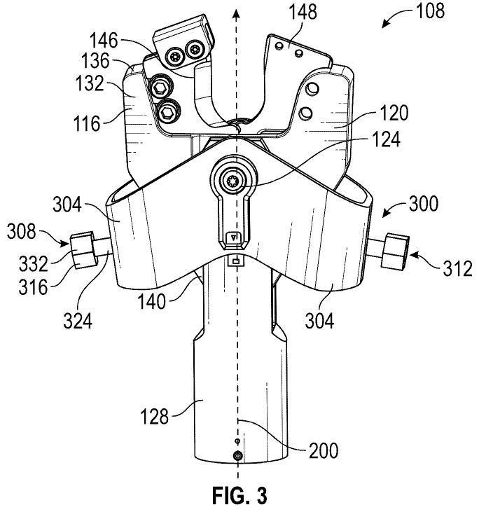

Referring to FIGS. 3 and 4, in some examples, the hydraulic tool 100 may include a return assembly 300 having a biasing member that is configured to act upon the jaws 116, 120 to aid the movement of the jaws 116, 120 from the closed position to the open position. The return assembly 300 may further include a collar 304 that is coupled to the hydraulic tool 100 (e.g., by the clevis pin 124). The collar 304 may extend from the clevis pin 124 to surround the work head 108. As illustrated in FIG. 3, the collar 304 may extend toward the housing 112 to specifically surround the proximal jaw sections 140.

Referring to FIG. 4, the collar 304 may retain a first biasing assembly 308 configured to bias the first jaw 116 from the closed position to the open position. The collar 304 may further retain a second biasing assembly 312 configured to bias the second jaw 120 to the open position. As illustrated in FIG. 4, each biasing assembly 308, 312 may include a plunger 316 (e.g., a spring screw). The plungers 316 may each include a contact head 320 configured to contact and act upon one of the proximal jaw sections 140. Specifically, the contact heads 320 of the plungers 316 may contact and act upon outer peripheral surfaces of the proximal jaw sections 140 (e.g.,. The plungers 316 may include a plunger shaft 324 that extends from the contact head 320 through a plunger hole 328 disposed in the collar 304 to a stop head 332, opposite the contact head 320. The plunger shaft 324 may be slidably moveable within the plunger hole 328. Furthermore, each of the contact head 320 and the stop head 332 may be larger than the plunger hole 328 to ensure that the plunger 316 is retained by the collar 304.

As illustrated in FIG. 4, each of the first and second biasing assemblies 308, 312 can include a biasing member 336. In some examples, the biasing members 336 may be a compression spring configured to bias the contact heads 320 of the first and second biasing assemblies 308, 312 against respective proximal jaw sections 140. For example, the biasing members 336 may be disposed around the plunger shaft 324 and compressed between the contact head 320 (e.g., a retainer) and an inner wall 340 of the collar 304 (e.g., a wall facing the jaws 116, 120). The biasing members 336 compressed between the contact heads 320 and the inner wall 340 of the collar 304 may thus act upon the contact heads 320 to bias the plungers 316 of the biasing assemblies 308, 312 toward the jaws 116, 120.

Still referring to FIG. 4, during actuation of the work head 108 from the open position to the closed position, the jaws 116, 120 may rotate about the clevis pin 124, causing the proximal sections of the jaws 116, 120 to rotate away from one another. Consequently, during actuation of the work head 108 from the open position to the closed position, the proximal jaw ends 144 may rotate against the biasing force of the biasing assemblies 308, 312. In the closed position of the jaws 116, 120, the biasing members 336 bias the contact heads 320 against the proximal jaw sections 140 may be compressed or loaded. Consequently, once the piston 166 begins to retract and ceases to act upon the jaws 116, 120 (e.g., once the workpiece disposed between the jaws 116, 120 is cut, crimped, punched, or otherwise worked upon), the biasing assemblies 308, 312 may exert a force on the proximal jaw sections 140 to encourage the rotation of the proximal jaw sections 140 toward one another, thus aiding the return of the jaws 116, 120 from the closed position to the open position.

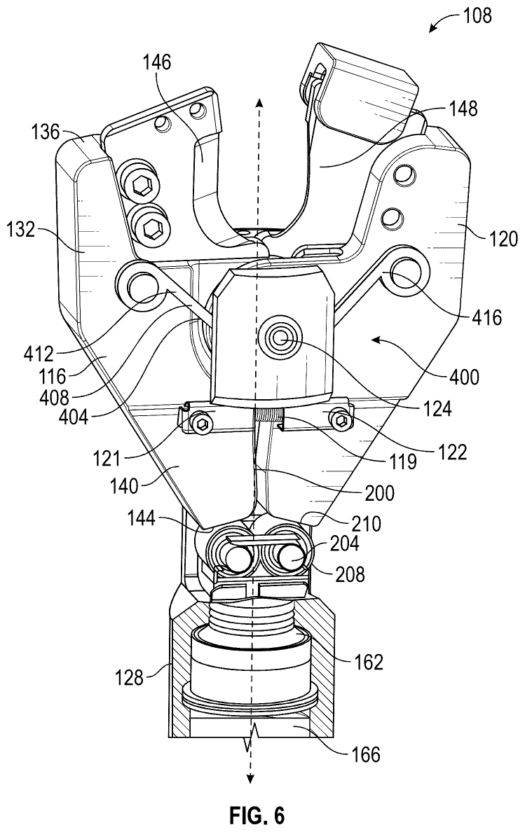

In some examples, a hydraulic cutting tool can include a return assembly that acts upon distal jaw sections of a work head. In this regard, for example, FIGS. 5 and 6 illustrate another embodiment of a return assembly 400. As illustrated in FIGS. 5 and 6, the return assembly 400 may include a biasing member 404 that is configured to act upon the jaws 116, 120 to aid the movement of the jaws 116, 120 from the closed position to the open position. In some examples, the biasing member 404 may be a torsion spring 408 having a spring body (e.g., coils of the spring) that extend around the clevis pin 124. The torsion spring 408 may include a first arm 412 that extends from the spring body and is coupled to the distal jaw section 132 of the first jaw 116. The torsion spring 408 may further include a second arm 416 that extends from the spring body and is coupled to the distal jaw section 132 of the second jaw 120. In other examples, the first arm 412 and second arm 416 of the torsion spring 408 may instead be coupled to the proximal jaw sections 140 of the first jaw 116 and the second jaw 120, respectively.

In some examples, the first arm 412 and the second arm 416 may be coupled to the first jaw 116 and the second jaw 120, respectively, by fasteners 418. For example, the fastener 418 may be a screw, a pin, or other fastening mechanism. In other examples, the fasteners 418 may be protrusions that extend monolithically from the first jaw and the second jaw 120. For example, the first arm 412 may extend around and be secured to the fastener 418 that is a protrusion on the first jaw 116, and the second arm 416 may extend around and be secured to the fastener 418 that is a protrusion on the second jaw 120. In some example, the ends of the arms 412, 416 can define openings that are configured to receive the fasteners 418. In other examples, the fasteners 418 can be a hole or opening that receives the ends of the arms 412, 416.

Still referring to FIGS. 5 and 6, during actuation of the work head 108 from the open position to the closed position, the jaws 116, 120 may rotate about the clevis pin 124, causing the distal jaw sections 132 to rotate toward one another. Consequently, during actuation of the work head 108 from the open position to the closed position, the distal jaw sections may rotate against the biasing force of the biasing member 404, thus loading the biasing member 404. Consequently, once the piston 166 begins to retract and ceases to act upon the jaws 116, 120 (e.g., once the workpiece disposed between the jaws 116, 120 is cut, crimped, punched, or otherwise worked upon), the biasing member 404 may exert a force on the distal jaw sections 132 to cause the rotation of the distal jaw sections 132 away from one another, thus aiding the return of the jaws 116, 120 from the closed position to the open position.

Referring specifically to FIG. 6, in some examples, the return assembly 400 may further include a second biasing member 420 that is coupled to the proximal jaw sections 140 of the jaws 116, 120. The second biasing member 420 may be a tension spring that is expanded or loaded when the work head 108 is in the open position. Consequently, once the piston 166 begins to retract and ceases to act upon the blades 146, 148, the second biasing member 420 may exert a force on the proximal jaw sections 140 to encourage the rotation of the proximal jaw sections 140 toward one another, thus aiding the return of the jaws 116, 120 from the closed position to the open position.

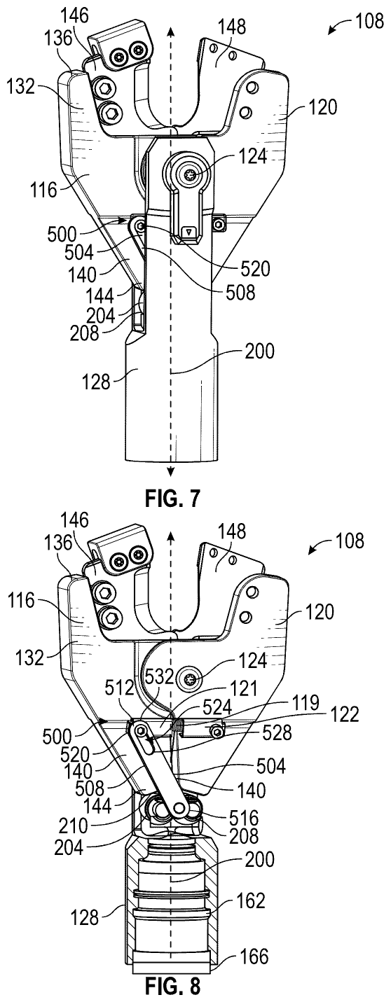

In some examples, a hydraulic cutting tool can include a return assembly that is coupled directly to a piston or ram head of the hydraulic tool. In this regard, for example, FIGS. 7 and 8 illustrate another embodiment of a return assembly 500. As illustrated in FIGS. 8, the return assembly 500 may include a linkage member 504 (e.g., a biasing member) that is configured to act upon the jaws 116, 120 to aid the movement of the jaws 116, 120 from the closed position to the open position. In some examples, the linkage member 504 may be a first link 508 that is directly or indirectly coupled to the piston 166. For example, the first link 508 may extend from a first end 512 and a second end 516. The first end 512 of the first link 508 may be coupled to the ram head 204, or another component otherwise moveable by the piston 166. The second end 516 of the first link 508 coupled to the proximal jaw section 140 of the first jaw 116.

As illustrated in FIG. 8, the first link 508 may be coupled to the proximal jaw section 140 via a pin 520 (e.g., or another type of fastener) extending from the proximal jaw section 140 through a slot 524 in the first link 508. In some examples, the pin 520 may be a screw, a pin, or other fastening mechanism. In other examples, the pin 520 may be a protrusion that extends monolithically from the first jaw 116. The slot 524 may be oblong and may be disposed adjacent the second end 516 of the first link 508. Furthermore, the slot 524 may extend along the first link 508 toward the first end 512. In some examples, the slot 524 may include a first slot end 528 disposed nearest the first end 512 of the first link 508, and a second slot end 532 disposed nearest the second end 516 of the first link 508. As described further below, the pin 520 may be slidably moveable within the slot 524, to allow the jaws 116, 120 to actuate from the open position to the closed position.

Still referring to FIG. 8, prior to actuation of the work head 108, the jaws 116, 120 may be disposed in the open position, and the pin 520 may be disposed at the second slot end 532 of the slot 524. During actuation of the work head 108 from the open position to the closed position, the piston 166 may advance the ram head 204 toward the clevis pin 124. As the ram head 204 advances toward the clevis pin 124, the first link 508, coupled to the ram head 204, may be actuated. Specifically, during actuation of the work head 108, the ram head 204 may translate the first link 508 such that the pin 520 slides from the second slot end 532 to the first slot end 528. Consequently, during actuation of the work head 108, the pin 520 may slide within the slot 524 to allow the jaws 116, 120 to open. In some cases, the first link 508 can be configured so that the first link 508 enacts minimal force on the pin 520, and thus the first jaw 116, in order to mitigate interference during actuation of the work head 108 caused by the first link 508. In other cases, the link 508 can be configured to apply force to the pin 520 to increase closing force. For example, the first link 508 can apply force to the pin 520 in a direction that is approximately in the direction of motion of the proximal jaw section 140 (e.g., to be substantially perpendicular to the rotation of proximal jaw section 140).

Once the work head 108 has performed the work, the piston 166 may begin to retract. As the piston 166 begins to retract (e.g., aided by a spring or other biasing member within the cylinder 162), the ram head 204 may translate the first link 508 such that the pin 520 slides from the first slot end 528 to the second slot end 532. As the piston 166 continues to retract, the first link 508 may begin to pull the pin 520 disposed in the second slot end 532, thus exerting a force on the proximal jaw section 140 of the first jaw 116. The force on the link 508 is provided by the extension spring 176 moving the ram 174. Specifically, the first link 508 may exert a force that is toward the extension axis 200 and the housing 112 of the tool 100. The first link 508 may therefore cause the rotation of the proximal jaw section 140 of the first jaw 116 toward the proximal jaw section 140 of the second jaw 120, thus aiding the return of the first jaw 116 from the closed position to the open position.

In some examples, a second lever member, substantially similar to the first link 508 may be coupled to the ram head and the second jaw 120. Similar to the first link 508, the second lever member may exert a force on the proximal jaw section 140 of the second jaw 120 that is toward the extension axis 200 and the housing 112 of the tool 100. The second lever member may therefore encourage the rotation of the proximal jaw section 140 of the second jaw 120 toward the proximal jaw section 140 of the first jaw 116, thus aiding the return of the second jaw 120 from the closed position to the open position.

In some examples, the return assembly 500 may further include a linkage member 504 that is coupled to the proximal jaw sections 140. The linkage member 504 may be a tension spring that is expanded or loaded when the jaws 116, 120 in the open position. Consequently, once the piston 166 begins to retract and ceases to act upon the jaws 116, 120, the linkage member 504 may exert a force on the proximal jaw sections 140 to encourage the rotation of the proximal jaw sections 140 toward one another, thus aiding the return of the jaws 116, 120 from the closed position to the open position.

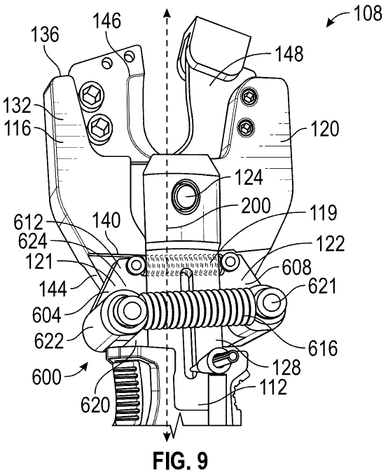

In some examples, a hydraulic cutting tool can include a return assembly that is configured to tensibly pull jaws of a work head to an open position. In this regard, for example, FIG. 9 illustrates another embodiment of a return assembly 600. As illustrated in FIG. 9, the return assembly 600 may include a first flange 604 (e.g., a bracket, a plate, etc.) that is coupled to and extends from the proximal jaw section 140 of the first jaw 116 toward the housing 112. The return assembly 300 may further include a second flange 608 that extends from the proximal jaw section 140 of the second jaw 120 toward the housing 112. In some examples, the first flange 604 may be coupled to the first jaw 116 at a first collar end 612 (e.g., via a fastener, a weld, or other known coupling method). Furthermore, the second flange 608 may be coupled to the second jaw 120 at the first collar end 612. In some case, the flange 604 can be formed with the jaw 116, 120. In some examples the first flange 604 is a first cover for the first spring 119 and the second flange 608 is a second cover for the first spring 119.

Opposite the first collar end 612, a resilient member 616 may be coupled to each of the first and second flanges 604, 608 at a second collar end 620. In some examples, the resilient member 616 may be coupled to the first and second flanges 604, 608 via fasteners 621 (e.g., a screw or other fastener). Specifically, the fasteners 621 may extend through and be retained by bosses 622 (e.g., threaded bosses) of the first and second flanges 604, 608, to couple the resilient member 616 to the first and second flanges 604, 608. In some examples, the bosses 622 may extend from a first exterior surface 624 of the flanges 604, 608 (e.g., a surface facing away from the jaws 116, 120). The bosses 622 may allow the resilient member 616 to extend around an exterior of the work head 108 (e.g., an exterior of the work body 128 of the work head 108). Additionally, the placement of the resilient member 616 may help to offset the resilient member 616 from the extension axis 200, thus mitigating interference to the actuation of the work head 108 by the piston 166.

In some examples, the resilient member 616 may be disposed adjacent the proximal jaw ends 144. In other examples, the resilient member 616 may be disposed further from the clevis pin 124 than the proximal jaw ends 144. Furthermore, separating the resilient member 616 a greater distance from the clevis pin 124 can allow the resilient member 616 to apply a greater torque on the proximal jaw sections 140, thus better aiding the return of the jaws 116, 120 from the closed position to the open position.

During actuation of the work head 108 from the open position to the closed position, the jaws 116, 120 may rotate about the clevis pin 124, causing the proximal jaw sections 140 to rotate away from one another, against the biasing force of the resilient member 616. The resilient member 616 may be a tension spring that is expanded or loaded when the jaws 116, 120 are in the open position. Consequently, once the piston 166 begins to retract and ceases to act upon the blades 146, 148, the resilient member 616 may exert a force on the proximal jaw sections 140 to encourage the rotation of the proximal jaw sections 140 toward one another, thus aiding the return of the jaws 116, 120 from the closed position to the open position.

In some examples, the return assembly 600 may include a second biasing member disposed opposite the resilient member 616. For example, the second biasing member may be coupled to the first flange 604 and the second flange 608 on a second exterior surface, disposed opposite the first exterior surface 624, and facing away from the first exterior surface 624. Similar to the resilient member 616, the second biasing member may be a tension spring that is expanded or loaded when the work head 108 is in the open position. Consequently, once the piston 166 begins to retract and ceases to act upon the blades 146, 148, the second biasing member may exert a force on the proximal jaw sections 140 to encourage the rotation of the proximal jaw sections 140 toward one another, thus aiding the return of the jaws 116, 120 from the closed position to the open position.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As described herein, unless otherwise specified or limited, the term “return assembly” refers to any single component, such as a spring, or multi-component assembly that is configured to aid movement of a work head of a tool between a closed position and an open position.

Additionally, unless otherwise specified or limited, the terms “about” and “approximate,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

We claim:

1. A power tool comprising:
a housing:
an actuator disposed within the housing and having a ram that is movable between a first position and a second position; and
a first jaw and a second jaw that are moveable relative to one another between a first configuration when the ram is in the first position and a second configuration when the ram is in the second position,
a first spring coupled to each of the first jaw and the second jaw to apply a first force to bias the first jaw and the second jaw to the first configuration; and
a return assembly to apply a second force to bias the first jaw to the first configuration.

2. The power tool of claim 1, wherein the return assembly includes a second spring to bias one of the first jaw.

3. The power tool of claim 2, wherein the return assembly includes a collar that is coupled to a yoke that pivotally supports the first jaw and the second jaw relative to the housing, and
wherein the second spring is coupled between the collar and the first jaw.

4. The power tool of claim 3, wherein the second spring is supported on a plunger that contacts the first jaw.

5. The power tool of claim 3, wherein the return assembly further includes a third spring to bias the second jaw, the third spring coupled between the collar and the first jaw.

6. The power tool of claim 2, wherein the second spring is a torsion spring that is coupled to a clevis pin that pivotally supports the first jaw and the second jaw on a yoke that is coupled to the housing.

7. The power tool of claim 6, wherein the torsion spring includes a first arm coupled to a distal end of the first jaw and a second arm that is coupled to a distal end of the second jaw.

8. The power tool of claim 2, wherein the second spring is a tension spring that is coupled between a first tang of the first jaw and a second tang of the second jaw.

9. The power tool of claim 8, wherein the second spring is coupled to the first tang via a first bracket and coupled to the second tang by a second bracket.

10. The power tool of claim 9, wherein a first end of the first spring is disposed in a first recess and the first bracket covers the first recess, and a second end of the first spring is disposed in a second recess and the second bracket covers the second recess.

11. The power tool of claim 1, wherein the return assembly includes a first link that is coupled to the first jaw and the ram.

12. The power tool of claim 11, wherein the second force is generated by a return spring of the actuator that causes the ram to move from the second position to the first position.

13. The power tool of claim 11, wherein the first link is pivotally coupled to a roller carrier that includes a roller to engage with a tang of the first jaw, and
wherein the first link includes a slot to pivotally and slidably couple to the first jaw.

14. The power tool of claim 11, wherein the return assembly includes a second link that is coupled to the second jaw and the ram.

15. The power tool of claim 11, wherein link provides a third force to bias the first jaw to the second configuration when the ram moves toward the second position.

16. A power tool comprising:
a housing:
an actuator disposed within the housing and having a ram that is movable between a retracted position and an extended position; and
a first jaw and a second jaw that are pivotally coupled to move between an open configuration when the ram is retracted and a closed configuration when the ram is extended, each of the first jaw and the second jaw including a tang that engages with the ram and a distal end that includes a blade;
a first spring coupled to the tang of each of the first jaw and the second jaw to apply a first force to bias the first jaw and the second jaw to the open configuration; and
a return assembly coupled to the tang of the first jaw to apply a second force to bias the first jaw to the open configuration.

17. The power tool of claim 16, wherein the first spring is positioned within a gap between a first leg and a second leg of a yoke that pivotally supports the first jaw and the second jaw, and the return assembly includes a second spring that is positioned external to the gap.

18. The power tool of claim 17, wherein the second spring is an extension spring that is coupled the tang of the first jaw and to the tang of the second jaw.

19. The power tool of claim 17, wherein the first spring is positioned in a first recess of the first jaw and a second recess of the second jaw, and
wherein the second spring is coupled first cover that covers the first recess and a second cover that covers the second recess.

20. A power tool comprising:
a housing;
a yoke coupled to the housing and including a first leg and a second leg that are spaced from one another to define a gap;
an actuator having a ram that is movable between a retracted position and an extended position; and
a first jaw and a second jaw that are pivotally coupled at the yoke to move between an open configuration when the ram is retracted and a closed configuration when the ram is extended, each of the first jaw and the second jaw including a tang that engages with the ram and a distal end that includes a blade;
a first spring coupled to the first jaw and the second jaw to apply a first force to bias the first jaw and the second jaw to the first configuration, the first spring positioned within the gap; and
a second spring to provide a second biasing force to the first jaw, the second spring positioned external to the gap.
